(19) United States
(12) Patent Application Publication
(10) Pub. No.: US 2005/0172241 A1
(43) Pub. Date: Aug. 4, 2005

(54) System and method for improved direct system clipboard

(75) Inventors: Fonda J. Daniels, Raleigh, NC (US); David Bruce Kumhyr, Austin, TX (US)

Correspondence Address: IBM CORPORATION- AUSTIN (JVL);C/O VAN LEEUWEN & VAN LEEUWEN, PO BOX 90609, AUSTIN, TX, 78709-0609, US

(73) Assignee: International Business Machines Corporation, Armonk, NY (US)

(21) Appl. No.: 10/753,821

(22) Filed: Jan. 8, 2004

(51) Int. Cl. G06F 3/00

(52) U.S. Cl. 715/770

(57) ABSTRACT

A system and method is provided to address the aforementioned challenges. A “paste to” function is provided in a source application from which data is being copied. When the user selects the “paste to” function, a list of potential target applications is provided. Potential target applications includes other open applications as well as different windows (e.g., documents) of a common application, such as a word processor. When the user selects one of the potential targets from the list, data is written to the “entry point” of the target application. If the user wishes to paste the same data to several different target applications, the user selects the “paste to” function as many times as needed in order to paste the data to the various other applications.

### BACKGROUND OF THE INVENTION

1. Technical Field

The present invention relates in general to a system and method for copying clipboard data. More particularly, the present invention relates to a system and method to paste data selected in one application directly to another application.

2. Description of the Related Art

Modern computer systems generally use multitasking operating systems in which it appears that multiple applications are running simultaneously. Multitasking operating systems are used as both single user operating systems, as well as multi-user operating systems. Examples of multitasking operating systems include IBM's OS/2™ operating system, IBM's AIX™ operating system, the Linux operating system, the UNIX™ operating system, Apple Macintosh™ operating systems (e.g., Apple's OS X™), and various operating systems provided by the Microsoft Corporation, including Windows XP™, Windows ME™, as well as other versions of Windows style operating systems.

Many of these multitasking operating systems provide a graphical user interface that provide containers (i.e., windows) for various applications running simultaneously on the computer system. Windows can either fill the entire display screen (“maximized”), fill a portion of the display screen, or be hidden (“minimized”), in which case the visible reference to the application is a small icon or item in a task list. Modern computer systems provide increasing amounts of memory and nonvolatile storage allowing more applications to be run simultaneously. Moreover, modern operating systems provide virtual memory and paging algorithms which increases the virtual address space allowing for even more applications to be run simultaneously.

When a user is using multiple applications, it is often advantageous to “copy” data from one application and “paste” it into another application. One way that this is performed is by having a system “clipboard” which is a memory area used to store “copied” data so that it can be “pasted” to another application by reading the copied data from the clipboard and writing into the other application. To accomplish this task, a user selects data in a first application from which data is being copied by using the keyboard or selection tool (e.g., mouse, track-point, etc.) to select the data. The user then instructs the application to write the selected data to the clipboard by using a “copy” or “cut” operation. As the names imply, a copy operation leaves the data in the first application, while a cut operation deletes the data from the first application.

The user then navigates to a second application to which the data is to be pasted. This navigation often utilizes a graphical user interface to select the second application. Once the second application has been selected and activated, the user positions the cursor in the application at the position where the data is to be pasted and requests a “paste” operation to be performed by the second application. The paste operation responds by reading the data from the clipboard and writing it to the second application, typically beginning at the cursor position.

A challenge with moving (or copying) data between applications using traditional methods is that it is tedious to move between the applications using the graphical user interface and using the various menus encountered to locate the appropriate commands (i.e., copy, cut, paste, etc.). This challenge is exacerbated when data needs to be copied from one application into several different applications, causing the user to have to both navigate to the other applications as well as locate and execute the “paste” command in each of the other applications.

What is needed, therefore, is a system and method for copying data to other applications without needing to navigate to the other applications and user menus or other commands in the target applications. What is further needed is a system and method that simplifies the copying of data from one application to multiple target applications.

### SUMMARY

A system and method is provided to address the aforementioned challenges. A “paste to” function is provided in a source application from which data is being copied. When the user selects the “paste to” function, a list of potential target applications is provided. Potential target applications includes other open applications as well as different windows (e.g., documents) of a common application, such as a word processor. When the user selects one of the potential targets from the list, data is written to the “entry point” of the target application. If the user wishes to paste the same data to several different target applications, the user selects the “paste to” function as many times as needed in order to paste the data to the various other applications.

The user begins by opening various applications, such as a word processor, a spreadsheet program, and an email program. Various files are opened using the applications. For example, the user might open a sales forecast document and a sales summary document using the word processor, a sales history spreadsheet and an expected sales spreadsheet using the spreadsheet program, an email message received from a salesperson, as well as a new email message directed to a sales manager in the email program. If the email message received from the salesperson includes data, such as recent sales numbers, that are needed in many of the other opened applications, the user simply selects the sales numbers, copies the data to the clipboard, and uses the “paste to” function available from the source document. In one embodiment, the “paste to” function pastes the last data written to the clipboard to the target application, while in another embodiment, using the “paste to” function while data has been selected at the source application causes the data to be both written to the clipboard and pasted to the target application.

The “paste to” function retrieves a list of opened applications and displays a window with a list of the opened applications. The user selects a target application from the displayed list and the sales numbers are pasted into the target application. In this manner, the user is able to select data and paste it into a number of other applications without ever leaving the graphical interface provided by the source application. In one embodiment, when the user selects a target application from the “paste to” list, the data is pasted to the selected target. In another embodiment, the user is able to select multiple targets from the “paste to” menu and, upon the user's request, the data is pasted into each of the target applications.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a screen diagram showing data being selected from a source application and copied into the clipboard buffer;

FIG. 2 is a set of screens showing data being pasted into a target application based upon the user's request;

FIG. 3 is a flowchart showing the steps taken in performing a directed paste operation;

FIG. 4 is a flowcharts showing the steps taken in retrieving locations for the directed paste operation;

FIG. 5 is a flowchart showing the steps taken in selecting paste to targets and pasting data;

FIG. 6 is a block diagram of a computing device capable of implementing the present invention.

### DETAILED DESCRIPTION

The following is intended to provide a detailed description of an example of the invention and should not be taken to be limiting of the invention itself. Rather, any number of variations may fall within the scope of the invention, which is defined in the claims following the description.

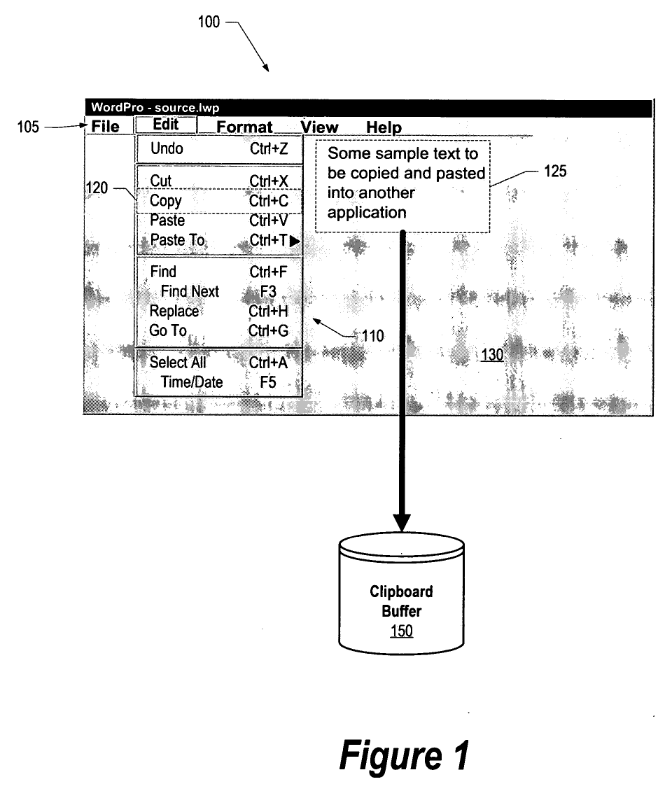

FIG. 1 is a screen diagram showing data being selected from a source application and copied into the clipboard buffer. The source application includes visible user interface window 100. Visible user interface window 100 is used to display application data in window 130. In the example shown, text block 125 has been selected by the user by using the keyboard or a pointing device such as a mouse, track point, etc.

Visible user interface window 100 also includes menu bar 105 that includes one or more menu items. In the example shown, edit menu 110 has been selected and, within edit menu 110, copy function 120 has been selected. As shown in the edit menu, a shortcut exists allowing the user to press a key combination (“control”+“c”) to select copy function 120. The copy function results in selected text block 125 being written to clipboard buffer 150.

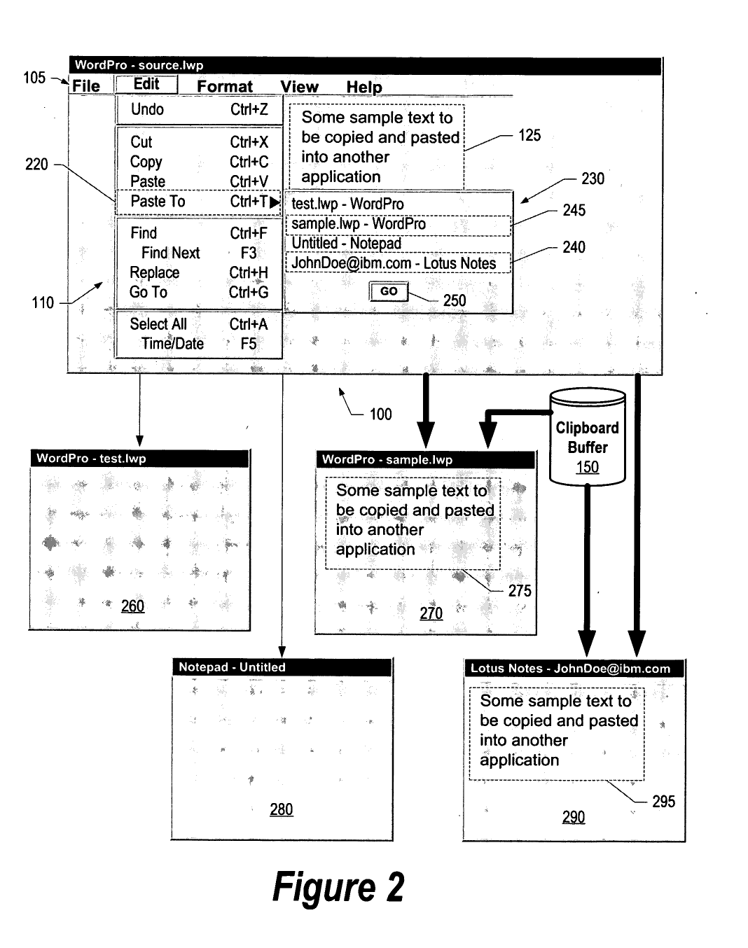

FIG. 2 is a set of screens showing data being pasted into a target application based upon the user's request. Edit menu 110 has been selected from menu bar 105 after selected text block 125 was written to clipboard buffer 150 as shown in FIG. 1.

In FIG. 2, the user selects “Paste to” menu item 220 which results in Paste to menu 230 being displayed. In addition, the user could have used the shortcut key combination (“control”+“t”) to select the “paste to” function. Paste to menu 230 includes an menu item for each potential target application/window currently opened in the computer system. If multiple data files are currently opened with the same application, then each of the data files is shown in menu 230 so that the user can select which of the application windows should receive the data. In the example shown, there are four potential targets: a WordPro document entitled “test.lwp” (260), a WordPro document entitled “sample.lwp” (270), an untitled document opened in the Notepad application (280), and an email note to “JohnDoe@ibm.com” (290).

The user selects one or more items from paste to menu 230 and, when all desired items have been selected, presses “go” command button 250 which is included in menu 230. In the example shown, item 240 (the Lotus Notes email note) and item 245 (the WordPro document entitled “sample.lwp”) have been selected. When the user selects “go” command button 250, data that was copied to clipboard buffer is pasted to the selected applications and appears as new text 275 in the WordPro document and as new text 295 in the Lotus email message.

The embodiment described above allows the user to select multiple target applications/windows before pressing the “go” command button. In an alternate embodiment, there is no “go” command button and, when the user selects one of the items from menu 230, the data is pasted to the corresponding application/window. In this alternate embodiment, the user can paste data into multiple target applications by repeatedly displaying menu 230 and selecting a different menu item each time the menu is displayed.

In one embodiment, data is written to clipboard buffer 150 as a result of a copy or cut operation, as shown in FIG. 1. In an alternate embodiment, when the “paste to” function is used a check is made to determine whether data in the source application has been selected (i.e., selected but not yet copied to the buffer). If data has been selected, then the data is copied to the clipboard buffer for pasting to one or more target applications/windows. As used herein, the term “application” means an application associated with a data file, unless otherwise noted. Using this definition, in FIG. 2 there is one source application (100), and four potential target applications (260, 270, 280, and 290). Each of the potential target applications corresponds to a paste to menu item shown in paste to menu 230.

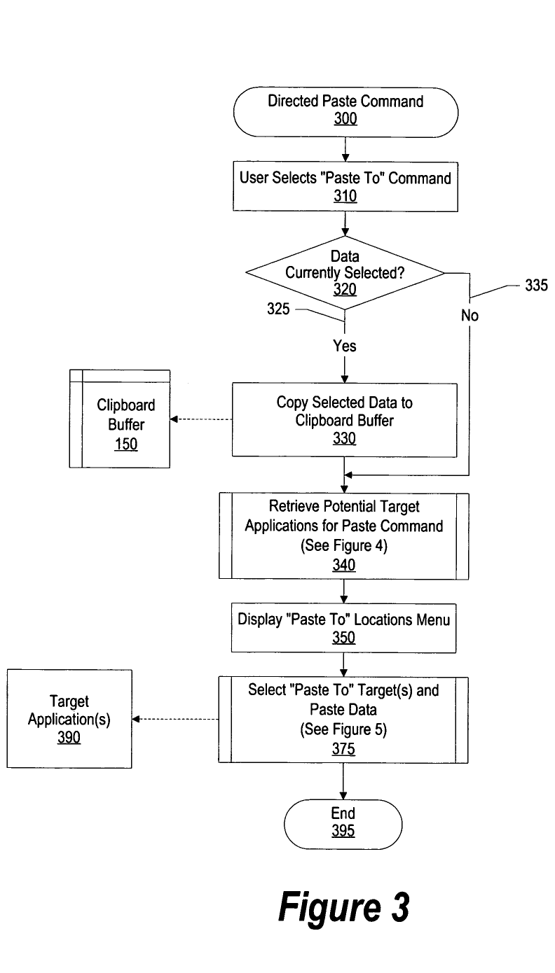

FIG. 3 is a flowchart showing the steps taken in performing a directed paste operation. Processing commences at 300 whereupon, at step 310, the user selects the “paste to” command. In FIG. 2, it was shown that the “paste to” command could be invoked by selecting the “paste to” menu item from the edit menu or by selecting the command's shortcut (i.e., “control”+“t”).

A determination is made as to whether data is currently selected in the source application that has not yet been written to the clipboard buffer (decision 320). If there is currently data that has been selected by the user in the source application but not yet written to the clipboard buffer, then decision 320 branches to “yes” branch 325 whereupon, at step 330, the selected data is written to clipboard buffer 150. On the other hand, if data is not currently selected in the source application, decision 320 branches to “no” branch 335 bypassing step 330 so that the last data written to clipboard buffer 150 will be used in any paste operations.

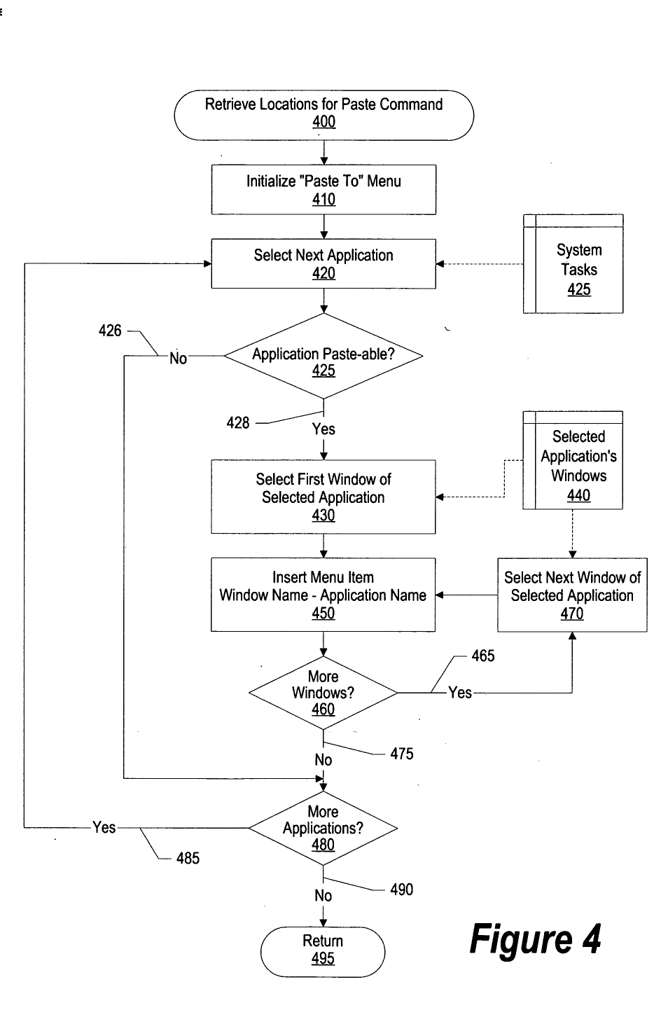

The potential target applications that are capable of receiving data from a paste operation are then retrieved (predefined process 340, see FIG. 4 and corresponding text for processing details). At step 350, the potential target applications are displayed to the user in a “paste to menu.”

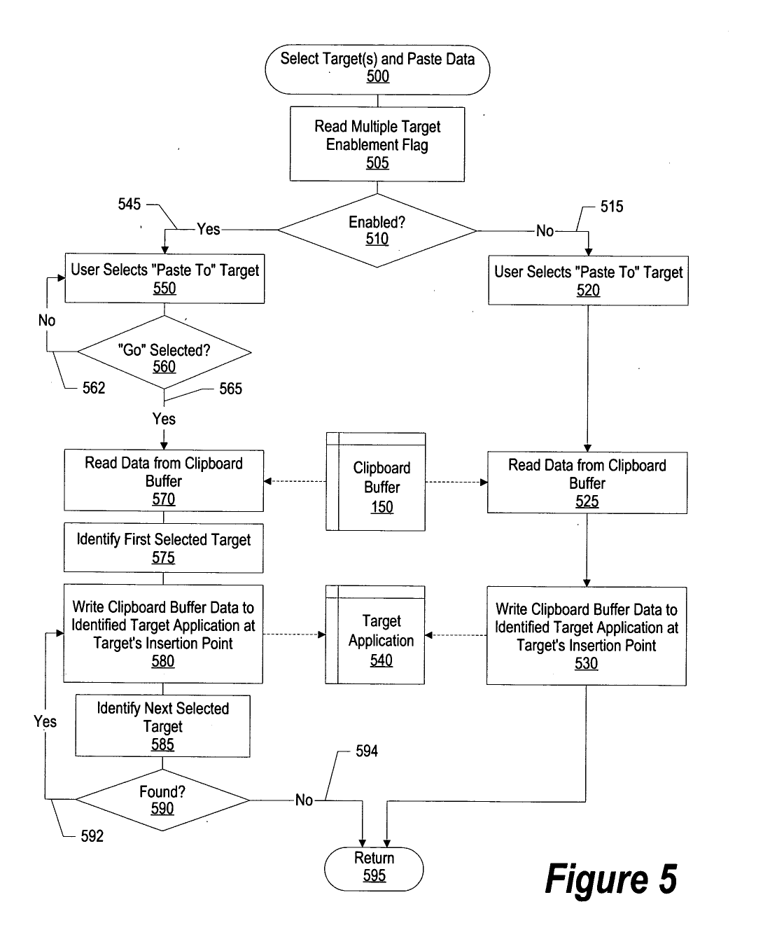

The user uses the displayed “paste to” menu to choose which application(s) is/are to receive data from the clipboard buffer (predefined process 375, see FIG. 5 and corresponding text for processing details). The result of predefined process 375 is one or more copies of the data in the clipboard buffer are written to one or more applications 390. Processing thereafter ends at 395.

FIG. 4 is a flowcharts showing the steps taken in retrieving locations for the directed paste operation. Processing commences at 400 whereupon, at step 410, the “paste to” menu is initialized with no items as no items have yet been added to the menu. At step 420, the first application is selected from an operating system table, such as system tasks 425, that includes a list of opened applications.

A determination is made as to whether the selected application is “paste-able” (decision 425). In other words, a decision is made as to whether it is possible to paste data into the selected application. Some applications do not have a user interface and others, such as a read-only help screen or application, have a user interface but do not have an entry point for data entry. The decision as to whether the application is “paste-able” can be made in a few different ways. One way is for a check to be made of the selected application's application programming interfaces (APIs) to determine if a “paste” or data entry API exists for the application. Another way to determine if an application is “paste-able” is by checking a list of default or user-selected applications into which the user would like to be able to paste data.

If the application is not paste-able, decision 425 branches to “no” branch 426 which bypasses steps taken to process a paste-able application and determines whether there are more applications to process. On the other hand, if the application is paste-able, decision 425 branches to “yes” branch 428 whereupon processing of the paste-able application commences.

Processing of a paste-able application commences by selecting the first (or only) window of the selected application from selected application's windows 440. At step 450, a menu item is created based upon the name of the window (i.e., the name of a document or spreadsheet file) and the name of the application and inserted into the “paste to” menu. A determination is made as to whether there are additional windows (i.e., documents, spreadsheet files, etc.) that are currently opened using the selected application (decision 460). If there are additional windows, decision 460 branches to “yes” branch 465 whereupon the next window for the selected application is selected (step 470) and processing loops back to create the menu item name and insert it into the “paste to” menu. This looping continues until there are no more windows associated with the selected application, at which point decision 460 branches to “no” branch 475.

A determination is made as to whether there are more applications that need to be processed and possibly added to the “paste to” menu (decision 480). If there are more applications to process, decision 480 branches to “yes” branch 485 whereupon processing loops back to select and process the next application from system tasks 425. This looping continues until there are no more applications to process, at which point the “paste to” menu is complete and decision 480 branches to “no” branch 490 whereupon processing returns to the calling program at 495. See FIG. 3 for steps that occur before and after processing of the steps shown in FIG. 4.

FIG. 5 is a flowchart showing the steps taken in selecting paste to targets and pasting data. Processing commences at 500 whereupon, at step 505, a multiple target enablement flag is read that indicates whether the user has requested that multiple selections can be made from the “paste to” menu, or whether the user has requested that a single selection can be made from the menu.

A determination is made as to whether multiple targeting is enabled (decision 510). If multiple targeting is not enabled, decision 510 branches to “no” branch 515 whereupon single target processing is performed. Single target processing commences at step 520, whereupon the user selects a “paste to” target application menu item from the displayed ‘paste to” menu. At step 525, data is read from the clipboard buffer, and at step 530, the data read from the clipboard buffer is written to target application 540. Single target processing thereafter returns at 595. See FIG. 3 for steps that occur before and after processing of the steps shown in FIG. 5.

Returning to decision 510, if multiple targeting has been enabled, decision 510 branches to “yes” branch 545 whereupon, multiple target processing is performed. Multiple target processing commences at step 550 with the user selecting a “paste to” menu item from the “paste to” menu. A determination is made as to whether the user selects the “go” command indicating that selections are finished (decision 560). If the user has not pressed the “go” command button, decision 560 branches to “no” branch 562 whereupon processing loops back to have the user select his or her next “paste to” target from the menu. This looping continues until the user presses the “go” command button, at which point decision 560 branches to “yes” branch 565 for processing of the selected “paste to” targets.

At step 570, data is read from clipboard buffer 150. At step 575, the first item selected in the “paste to” menu item is identified. The data read from the clipboard buffer is written to identified target application 540 at the identified target application's insertion point (step 580). The insertion point is typically the current cursor location in the target application when the application is activated. At step 585, an attempt is made to identify the next item selected in the “paste to” menu item. A determination is made as to whether a next item is identified (decision 590). If a next item is identified, decision 590 branches to “yes” branch 592 whereupon processing loops back to process the newly identified item and write the data from the clipboard buffer to the target application that corresponds to the identified item. This looping continues until all selected targets in the “paste to” menu have been identified and processed, at which point decision 590 branches to “no” branch 594 and processing returns at 595. See FIG. 3 for steps that occur before and after processing of the steps shown in FIG. 5.

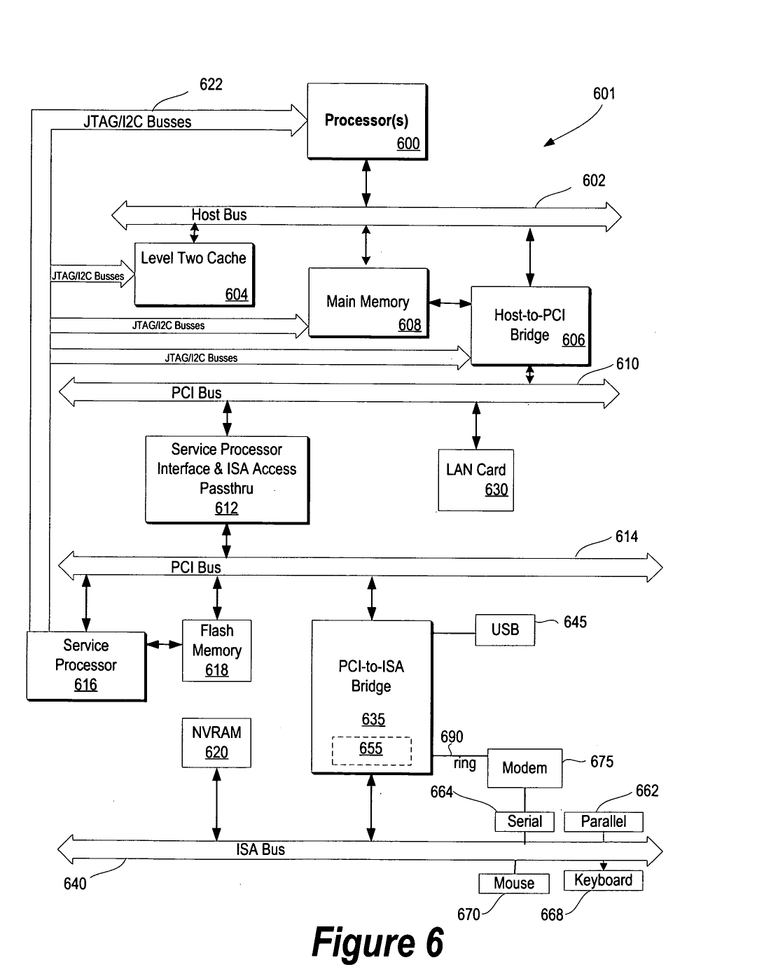

FIG. 6 illustrates information handling system 601 which is a simplified example of a computer system capable of performing the computing operations described herein. Computer system 601 includes processor 600 which is coupled to host bus 602. A level two (L2) cache memory 604 is also coupled to host bus 602. Host-to-PCI bridge 606 is coupled to main memory 608, includes cache memory and main memory control functions, and provides bus control to handle transfers among PCI bus 610, processor 600, L2 cache 604, main memory 608, and host bus 602. Main memory 608 is coupled to Host-to-PCI bridge 606 as well as host bus 602. Devices used solely by host processor(s) 600, such as LAN card 630, are coupled to PCI bus 610. Service Processor Interface and ISA Access Pass-through 612 provides an interface between PCI bus 610 and PCI bus 614. In this manner, PCI bus 614 is insulated from PCI bus 610. Devices, such as flash memory 618, are coupled to PCI bus 614. In one implementation, flash memory 618 includes BIOS code that incorporates the necessary processor executable code for a variety of low-level system functions and system boot functions.

PCI bus 614 provides an interface for a variety of devices that are shared by host processor(s) 600 and Service Processor 616 including, for example, flash memory 618. PCI-to-ISA bridge 635 provides bus control to handle transfers between PCI bus 614 and ISA bus 640, universal serial bus (USB) functionality 645, power management functionality 655, and can include other functional elements not shown, such as a real-time clock (RTC), DMA control, interrupt support, and system management bus support. Nonvolatile RAM 620 is attached to ISA Bus 640. Service Processor 616 includes JTAG and I2C busses 622 for communication with processor(s) 600 during initialization steps. JTAG/I2C busses 622 are also coupled to L2 cache 604, Host-to-PCI bridge 606, and main memory 608 providing a communications path between the processor, the Service Processor, the L2 cache, the Host-to-PCI bridge, and the main memory. Service Processor 616 also has access to system power resources for powering down information handling device 601.

Peripheral devices and input/output (I/O) devices can be attached to various interfaces (e.g., parallel interface 662, serial interface 664, keyboard interface 668, and mouse interface 670 coupled to ISA bus 640. Alternatively, many I/O devices can be accommodated by a super I/O controller (not shown) attached to ISA bus 640.

In order to attach computer system 601 to another computer system to copy files over a network, LAN card 630 is coupled to PCI bus 610. Similarly, to connect computer system 601 to an ISP to connect to the Internet using a telephone line connection, modem 675 is connected to serial port 664 and PCI-to-ISA Bridge 635.

While the computer system described in FIG. 6 is capable of executing the processes described herein, this computer system is simply one example of a computer system. Those skilled in the art will appreciate that many other computer system designs are capable of performing the processes described herein.

One of the preferred implementations of the invention is a client application, namely, a set of instructions (program code) in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method for pasting data, said method comprising:
selecting data in a source application;
displaying a menu in the source application of one or more potential target applications;
receiving a selection of one or more of the potential target applications, the receiving resulting in one or more selected target applications; and
writing the selected data to each of the selected target applications.

2. The method of claim 1 further comprising:
storing the selected data in a clipboard buffer after the data has been selected.

3. The method of claim 1 further comprising:
reading a multiple target enablement flag;
allowing a user to select a plurality of potential target applications in response to the multiple target enablement flag being set; and
allowing the user to select one potential target application in response to the multiple target enablement flag not being set.

4. The method of claim 1 further comprising:
storing the selected data in a clipboard buffer in response to determining that a “paste to” function has been requested by a user.

5. The method of claim 1 further comprising:
creating the menu of potential source applications, the creation of the menu including:
identifying a plurality of applications currently being executed by a computer system;
identifying one or more data files associated with each of the identified applications;
forming a plurality of names based upon a name of the identified applications and the identified data files; and
inserting the plurality of names in a menu.

6. The method of claim 5 further comprising:
determining whether each of the plurality of applications is capable of receiving pasted data; and
only including the applications capable of receiving pasted data in the plurality of applications currently being executed by the computer system.

7. The method of claim 1 further comprising:
identifying an insertion point for each of the selected target applications, wherein the selected data is written to each of the selected target applications beginning at each selected target's insertion point.

8. An information handling system comprising:
one or more processors;
a memory connected to the processors;
a multitasking operating system stored in the memory and executed by the processors, wherein the operating system manages a plurality of applications;
a display device displaying a user interface corresponding to one or more of the applications; and
a data pasting tool for pasting data from one of the applications to one or more other applications, the data pasting tool including:
means for selecting data in a source application;
means for displaying a menu in the source application of one or more potential target applications;
means for receiving a selection of one or more of the potential target applications, the receiving resulting in one or more selected target applications; and
means for writing the selected data to each of the selected target applications.

9. The information handling system of claim 8 further comprising:
means for storing the selected data in a clipboard buffer after the data has been selected.

10. The information handling system of claim 8 further comprising:
means for reading a multiple target enablement flag;
means for allowing a user to select a plurality of potential target applications in response to the multiple target enablement flag being set; and
means for allowing the user to select one potential target application in response to the multiple target enablement flag not being set.

11. The information handling system of claim 8 further comprising:
means for storing the selected data in a clipboard buffer in response to determining that a “paste to” function has been requested by a user.

12. The information handling system of claim 8 further comprising:
means for creating the menu of potential source applications, the creation of the menu including:
means for identifying a plurality of applications currently being executed by a computer system;
means for identifying one or more data files associated with each of the identified applications;
means for forming a plurality of names based upon a name of the identified applications and the identified data files; and
means for inserting the plurality of names in a menu.

13. The information handling system of claim 12 further comprising:
means for determining whether each of the plurality of applications is capable of receiving pasted data; and
means for only including the applications capable of receiving pasted data in the plurality of applications currently being executed by the computer system.

14. A computer program product stored on a computer operable media for pasting data, said computer program product comprising:
means for selecting data in a source application;
means for displaying a menu in the source application of one or more potential target applications;
means for receiving a selection of one or more of the potential target applications, the receiving resulting in one or more selected target applications; and
means for writing the selected data to each of the selected target applications.

15. The computer program product of claim 14 further comprising:
means for storing the selected data in a clipboard buffer after the data has been selected.

16. The computer program product of claim 14 further comprising:
means for reading a multiple target enablement flag;
means for allowing a user to select a plurality of potential target applications in response to the multiple target enablement flag being set; and
means for allowing the user to select one potential target application in response to the multiple target enablement flag not being set.

17. The computer program product of claim 14 further comprising:
means for storing the selected data in a clipboard buffer in response to determining that a “paste to” function has been requested by a user.

18. The computer program product of claim 14 further comprising:
means for creating the menu of potential source applications, the creation of the menu including:
means for identifying a plurality of applications currently being executed by a computer system;
means for identifying one or more data files associated with each of the identified applications;
means for forming a plurality of names based upon a name of the identified applications and the identified data files; and
means for inserting the plurality of names in a menu.

19. The computer program product of claim 18 further comprising:
means for determining whether each of the plurality of applications is capable of receiving pasted data; and
means for only including the applications capable of receiving pasted data in the plurality of applications currently being executed by the computer system.

20. The computer program product of claim 14 further comprising:
means for identifying an insertion point for each of the selected target applications, wherein the selected data is written to each of the selected target applications beginning at each selected target's insertion point.
